(19) United States
(12) Patent Application Publication
(10) Pub. No.: US 2026/0135037 A1
(43) Pub. Date: May 14, 2026

(54) MULTILAYER CERAMIC CAPACITOR

(71) Applicant: Murata Manufacturing Co., Ltd., Nagaokakyo-shi (JP)

(72) Inventors: Akitaka DOI, Nagaokakyo-shi (JP); Kazuhisa UCHIDA, Nagaokakyo-shi (JP)

(21) Appl. No.: 19/443,112

(22) Filed: Jan. 8, 2026

Related U.S. Application Data
(63) Continuation of application No. PCT/JP2024/021388, filed on Jun. 12, 2024.

(30) Foreign Application Priority Data
Jul. 28, 2023 (JP) 2023-123677

(51) Int. Cl. H01G 4/232; H01G 4/012; H01G 4/12; H01G 4/30

(52) U.S. Cl. CPC H01G 4/232; H01G 4/012; H01G 4/1209; H01G 4/30

(57) ABSTRACT

A multilayer ceramic capacitor includes a laminate including an inner layer portion in which a dielectric layer and an internal electrode layer are alternately laminated, outer layer portions sandwiching the inner layer portion in a lamination direction, and side gap portions sandwiching the inner layer portion in a width direction, and an external electrode on each end surface in a length direction of the laminate and connected to the internal electrode layer. An average particle size Rd of ceramic grains in the dielectric layers, an average particle size Rs of ceramic grains in the side gap portions, and an average particle size Ro of ceramic grains in the outer layer portions satisfy Rd≤Rs<Ro.

### CROSS REFERENCE TO RELATED APPLICATIONS

This application claims the benefit of priority to Japanese Patent Application No. 2023-123677 filed on Jul. 28, 2023 and is a Continuation Application of PCT Application No. PCT/JP2024/021388 filed on Jun. 12, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, reduced size and increased capacitance have been required in multilayer ceramic capacitors. Therefore, in order to provide dielectric layers with high permittivity in the inner layer portions that generate capacitance, grain growth of ceramic grains of the dielectric layers is promoted, and normally, it is designed so that the particle size of ceramic grains in the dielectric layers of the inner layer portions is greater than the particle size of ceramic grains in the outer layer portions and side gap portions.

However, even when the permittivity of the dielectric layers is increased by promoting grain growth of ceramic grains, when such multilayer ceramic capacitors are mounted, AC voltage characteristics and DC bias characteristics may deteriorate depending on the environment of use.

In addition, promoting grain growth of ceramic grains tends to impair the smoothness of dielectric layers when the dielectric layers are made thinner to increase capacitance, making short circuits and insulation failures more likely to occur, which also tends to lead to a problem of reduced reliability of multilayer ceramic capacitors.

Therefore, the development of multilayer ceramic capacitors that achieve both AC voltage characteristics and DC bias characteristics is required.

### SUMMARY OF THE INVENTION

Example embodiments of the present invention provide multilayer ceramic capacitors that each achieve both AC voltage characteristics and DC bias characteristics.

The inventors of example embodiments of the present invention have discovered that, when the average particle size Rd of ceramic grains in dielectric layers, the average particle size Rs of ceramic grains in side gap portions, and the average particle size Ro of ceramic grains in outer layer portions satisfy a predetermined relationship, it is possible to achieve both AC voltage characteristics and DC bias characteristics, thereby completing the present invention.

An example embodiment of the present invention provides a multilayer ceramic capacitor which includes a multilayer body including an inner layer portion in which dielectric layers and internal electrode layers are alternately laminated in a lamination direction, outer layer portions sandwiching the inner layer portion in the lamination direction, and side gap portions sandwiching the inner layer portion in a width direction intersecting the lamination direction, and external electrodes each on a corresponding one of both end surfaces in a length direction intersecting the lamination direction and the width direction of the multilayer body, and each connected to one or more of the internal electrode layers. An average particle size Rd of ceramic grains in the dielectric layers, an average particle size Rs of ceramic grains in the side gap portions, and an average particle size Ro of ceramic grains in the outer layer portions satisfy Rd≤Rs<Ro.

According to example embodiments of the present invention, multilayer ceramic capacitors that each achieve both AC voltage characteristics and DC bias characteristics.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to an example embodiment of the present invention.

FIG. 2 is a cross-sectional view of the multilayer ceramic capacitor taken along the line II-II shown in FIG. 1.

FIG. 3 is a cross-sectional view of the multilayer ceramic capacitor taken along the line III-III shown in FIG. 1.

FIG. 4 is an image of each region in a cross section of a multilayer ceramic capacitor according to an example embodiment of the present invention photographed by an electron microscope (drawing substitute photograph).

FIG. 5 provides an image of each region in a cross section of a multilayer ceramic capacitor according to an example embodiment of the present invention and a conventional multilayer ceramic capacitor photographed by an electron microscope (drawing substitute photograph).

### DETAILED DESCRIPTION OF THE EXAMPLE EMBODIMENTS

Example embodiments of the present invention will be described in detail below with reference to the drawings.

Hereinafter, a multilayer ceramic capacitor according to an example embodiment of the present invention will be described. However, the present invention is not limited thereto. In addition, the drawings may be schematically simplified and drawn in order to explain the contents of example embodiments of the present invention, and the drawn components or the ratio of the dimensions between the components may not coincide with the ratio of the dimensions described in the specification. In addition, components described in the specification may be omitted in the drawings or may be drawn with the number of components omitted.

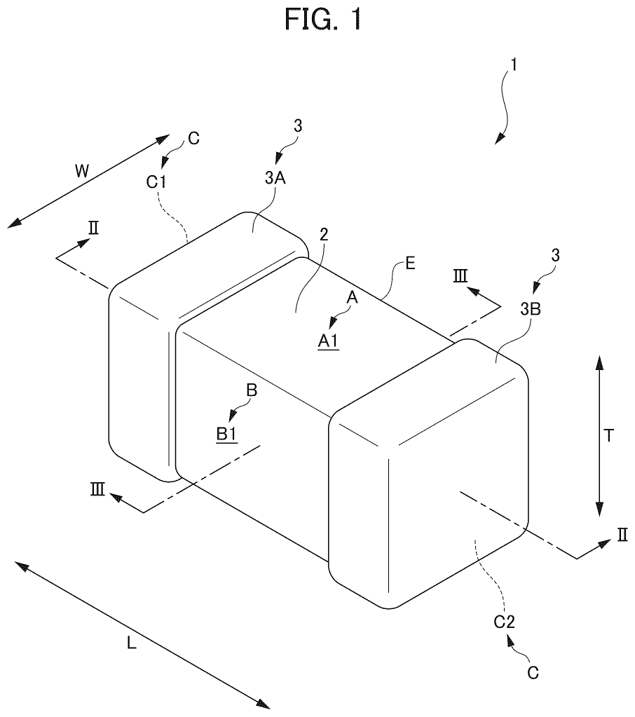

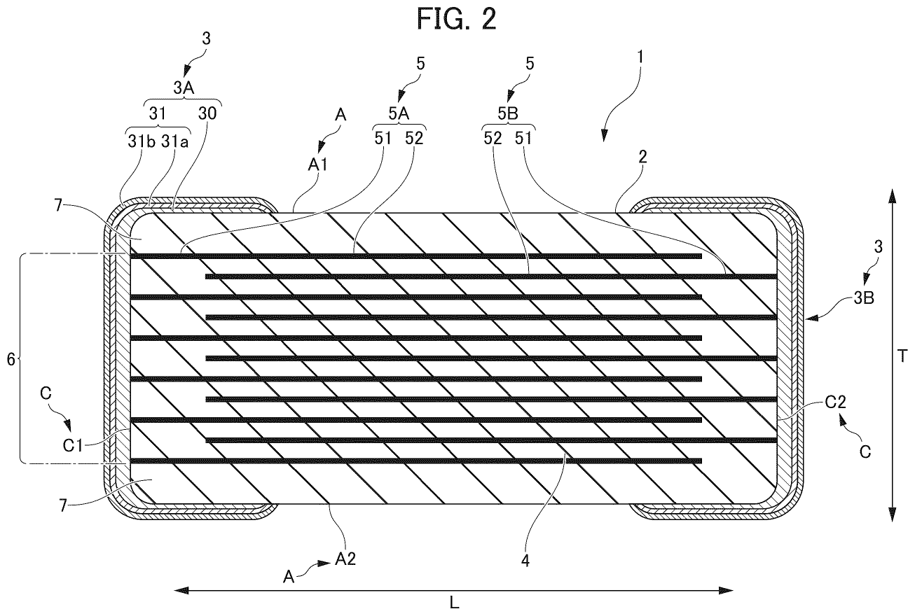

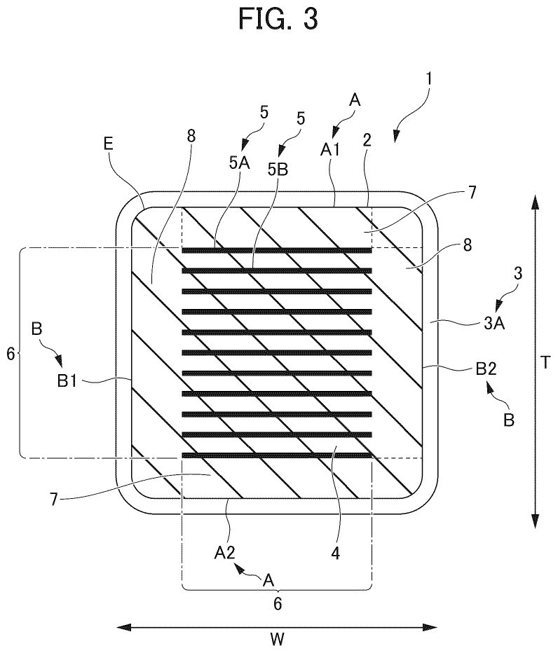

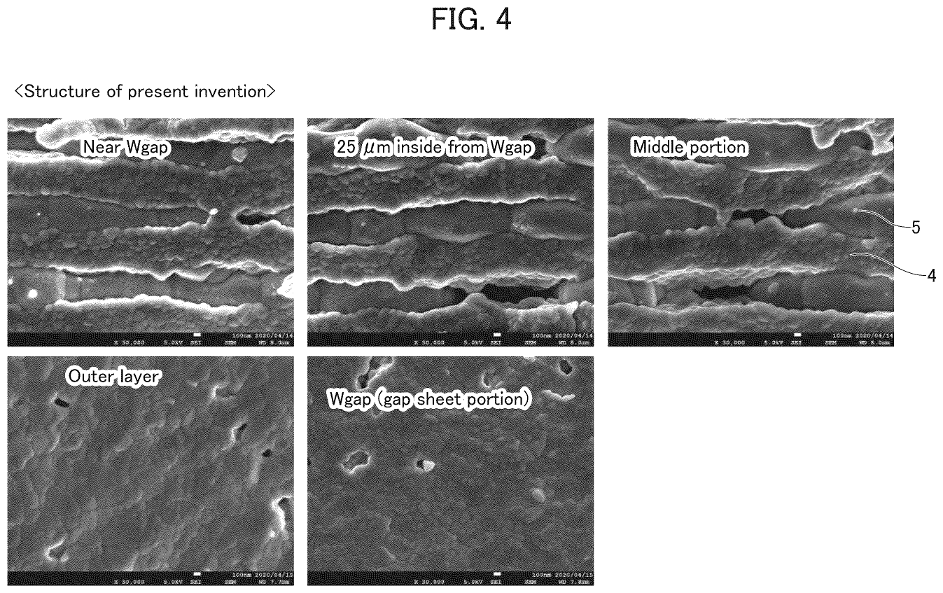

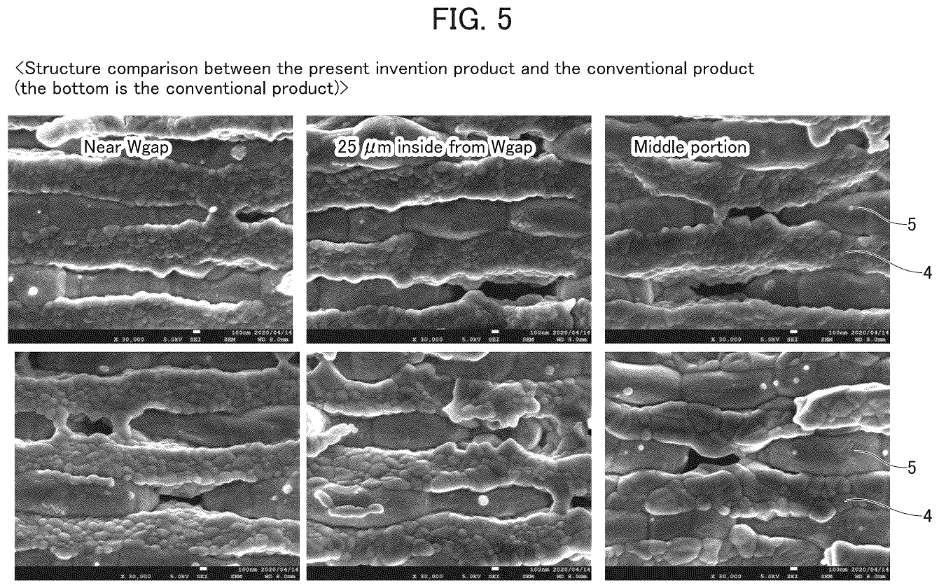

FIGS. 1 to 3 each show the shape and configuration of a multilayer ceramic capacitor 1 according to an example embodiment of the present invention. FIG. 1 is a schematic perspective view of the multilayer ceramic capacitor 1. FIG. 2 is a cross-sectional view (LT cross-sectional view) of the multilayer ceramic capacitor 1 taken along the line II-II of the middle portion in the width direction W shown in FIG. 1. FIG. 3 is a cross-sectional view (WT cross-sectional view) of the multilayer ceramic capacitor 1 taken along the line III-III of the middle portion in the length direction L shown in FIG. 1. FIG. 4 provides an image of each region in a WT cross section of a multilayer ceramic capacitor 1 according to an example embodiment of the present invention photographed by an electron microscope. FIG. 5 provides an image of each region in a WT cross section of a multilayer ceramic capacitor 1 according to an example embodiment of the present invention and a conventional multilayer ceramic capacitor photographed by an electron microscope. In addition, the configuration of the multilayer ceramic capacitor 1 will be described with reference to a lamination direction T defined as a direction in which the dielectric layers 4 and the internal electrode layers 5 are laminated, a length direction L defined as a direction perpendicular or substantially perpendicular to the lamination direction T, and a width direction W defined as a direction perpendicular or substantially perpendicular to the lamination direction T and the length direction L. In the example embodiments of the present invention, the width direction W, the length direction L, and the lamination direction T are orthogonal or substantially orthogonal to each other, but are not necessarily orthogonal to each other, and may intersect each other.

The multilayer ceramic capacitor 1 has a rectangular or substantially rectangular shape, and includes a multilayer body 2 and a pair of external electrodes 3 provided at both ends of the multilayer body 2. The multilayer body 2 includes an inner layer portion 6 including a plurality of sets of a dielectric layer 4 and an internal electrode layer 5.

Among the six outer surfaces of the multilayer body 2, a pair of outer surfaces opposed to each other in the lamination direction T is defined as a first main surface A1 and a second main surface A2, a pair of outer surfaces opposed to each other in the width direction W is defined as a first lateral surface B1 and a second lateral surface B2, and a pair of outer surfaces opposed to each other in the length direction L is defined as a first end surface C1 and a second end surface C2.

The first main surface A1 and the second main surface A2 are collectively referred to as a main surface A, the first lateral surface B1 and the second lateral surface B2 are collectively referred to as a lateral surface B, and the first end surface C1 and the second end surface C2 are collectively referred to as an end surface C.

The multilayer body 2 includes an inner layer portion 6, outer layer portions 7 provided on sides of the inner layer portion 6 adjacent to the main surfaces A, and side gap portions 8 provided on sides of the inner layer portion 6 adjacent to the lateral surfaces B. In the multilayer body 2, it is preferable that ridge portions E are rounded. Each of the ridge portions E refers to a portion where the two surfaces of the multilayer body 2, that is, the main surface A and the lateral surface B, the main surface A and the end surface C, or the lateral surface B and the end surface C intersect with each other, and also includes corner portions where the main surface A, the lateral surface B, and the end surface C intersect with each other.

The inner layer portion 6 includes a plurality of sets of dielectric layers 4 and internal electrode layers 5 alternately laminated along the lamination direction T.

Each of the dielectric layers 4 is made of a ceramic material. As the ceramic material, for example, a dielectric ceramic including BaTiO₃ as a main component may be used. Further, as the ceramic material, a material obtained by adding at least one subcomponent such as, for example, a Mn compound, a Fe compound, a Cr compound, a Co compound, or a Ni compound to these main components may be used.

Each of the internal electrode layers 5 is preferably made of a metal material represented by, for example, Ni, Cu, Ag, Pd, an Ag—Pd alloy, Au, or the like.

The internal electrode layers 5 include a plurality of first internal electrode layers 5A and a plurality of second internal electrode layers 5B. Each of the first internal electrode layers 5A and each of the second internal electrode layers 5B are alternately provided with a corresponding one of the dielectric layers 4 interposed therebetween. When it is not necessary to particularly distinguish between the first internal electrode layer 5A and the second internal electrode layer 5B, they are collectively described as the internal electrode layer 5.

Each of the internal electrode layers 5 includes a counter portion 52 where the first internal electrode layers 5A and the second internal electrode layers 5B are opposed to each other, and an extension portion 51 where the first internal electrode layers 5A and the second internal electrode layers 5B are not opposed to each other. The extension portion 51 extends from the counter portion 52 toward a corresponding one of the end surfaces C. Each of the extension portions 51 includes an end portion that is exposed at the end surface C and is electrically connected to the external electrode 3. The directions in which the extension portions 51 extend differ between the first internal electrode layers 5A and the second internal electrode layers 5B, and the extension portions 51 extend alternately toward the first end surface C1 and the second end surface C2. Charges are accumulated between the counter portions 52 of the first internal electrode layers 5A and the second internal electrode layers 5B adjacent to one another in the lamination direction T via the dielectric layer 4, thus defining and functioning as a capacitor.

The outer layer portions 7 are each provided on a side of the inner layer portion 6 adjacent to a corresponding one of the main surfaces A. The outer layer portions 7 are made of a ceramic material and can be made of the same material as the dielectric layers 4 of the inner layer portion 6.

The side gap portions 8 are provided adjacent to both lateral surfaces B of the inner layer portion 6 in the multilayer body 2. The side gap portions 8 can be integrally formed with the same material as the dielectric layers 4, but may be formed by attaching a ceramic material similar to the dielectric layers 4 to both lateral surfaces of the inner layer portion 6 in the width direction W. The side gap portions 8 are also referred to as W gap portions.

The external electrodes 3 may have a known configuration. For example, each of the external electrodes 3 may include a laminated structure including a base electrode layer 30, a first plated layer 31a, and a second plated layer 31b from the end surface C side of the multilayer body 2. The base electrode layer 30 can include a metal such as Ni or Cu, for example. The base electrode layer 30 may also include ceramic powder as a co-material. The first plated layer 31a is, for example, a Ni plated layer. The second plated layer 31b is, for example, a Sn plated layer. An electrically conductive resin layer may be provided between the base electrode layer 30 and the first plated layer 31a. The electrically conductive resin layer is a layer including electrically conductive metal particles such as Cu, Ag, and Ni, and a resin, for example. The external electrodes 3 are not limited in their configuration as long as they are electrically connected to the internal electrode layers 5 and define and function as external input/output terminals.

Next, an example of a method of manufacturing the multilayer ceramic capacitor 1 according to an example embodiment of the present invention will be described. The manufacturing method of the multilayer ceramic capacitor includes a multilayer body manufacturing step, a firing step, and an external electrode forming step in this order.

In the multilayer body manufacturing step, first, a ceramic slurry obtained by adding a solvent or the like to a ceramic material for forming the dielectric layers 4, and an electrically conductive paste obtained by adding a solvent or the like to a metal material for forming the internal electrode layers 5 are prepared. Then, material sheets are produced by printing internal electrode patterns of the internal electrode layers 5 with the electrically conductive paste on the surface of ceramic green sheets for lamination formed by molding the ceramic slurry into a sheet shape. Next, a plurality of material sheets are stacked such that the internal electrode patterns are shifted by about a half pitch in the length direction between adjacent material sheets. Furthermore, ceramic green sheets for manufacturing outer layer portions that define and function as outer layer portions are stacked on both sides of the plurality of laminated material sheets, and then thermocompression bonded to form a mother block member. A plurality of multilayer chips are manufactured by dividing the mother block member along cutting lines corresponding to the dimensions of the multilayer body. Thereafter, the multilayer chips are barrel polished to round the corners and ridge portions, and then fired in a firing step. As a result, the ceramic material and metal material included in the multilayer chips are fired to form the multilayer body 2 including the plurality of dielectric layers 4 and the plurality of internal electrode layers 5.

According to the above steps, although the side gap portions 8 can be formed simultaneously with the formation of the multilayer body 2, by cutting out from the mother block member, first, an inner layer portion may be formed in which the end portions of the internal electrode layers in the width direction W are exposed on both lateral surfaces, and then the side gap portions 8 may be attached to both lateral surfaces of the inner layer portion so as to cover the exposed end portions of the internal electrode layers to form the multilayer body 2. At this time, for the side gap portions 8 to be attached, a dielectric ceramic material the same as or similar to the dielectric layers 4 may be used.

In the firing step, each of the multilayer chips is subjected to a debinding treatment and a firing treatment to form the base body. Through the firing treatment, the electrically conductive paste layer and the green sheet for manufacturing the dielectric layer are co-fired to become the internal electrode layers 5 and the dielectric layers 4, respectively. The conditions for the debinding treatment may be determined according to the type of organic binder included in the green sheet and the electrically conductive paste layer. The firing treatment is required to be performed at a temperature at which the multilayer chip is sufficiently densified. For example, it is required to be performed under conditions of holding at a temperature of about 1200° C. or more and about 1300° C. or less for about 0 minutes or more and about 10 minutes or less. The firing is performed in an atmosphere in which the BaTiO₃-based compound as the main component is not reduced, and oxidation of the electrically conductive material is reduced or prevented. For example, it is required to be performed in an N₂—H₂-H₂O gas flow with an oxygen partial pressure of about 1.8×10⁻⁹ to about 8.7×10⁻¹⁰ MPa. Furthermore, an annealing treatment may be performed after firing. The grain growth of ceramic grains can be adjusted by the conditions of the firing treatment and the annealing treatment.

In the external electrode forming step, the external electrodes 3 are formed on the multilayer body 2 to manufacture the multilayer ceramic capacitor 1. The formation of the external electrodes 3 can be performed using known techniques. For example, an electrically conductive paste including an electrically conductive component such as, for example, Cu or Ni as a main component is applied on the end surfaces where the internal electrode layers 5 of the multilayer body 2 are exposed, and then fired to form the base electrode layers 30. The base electrode layers 30 may be formed by a method in which an electrically conductive paste is applied to both end surfaces of the green base body before firing and then firing treatment is performed. After forming the base electrode layers 30, electrolytic plating is performed to form plated films of Ni, Sn, or the like on the surfaces of the base electrode layers 30. As a result, the multilayer ceramic capacitor 1 is manufactured.

The following evaluation tests were conducted on the multilayer ceramic capacitors.

The specifications regarding dimensions, ceramic material, thickness of dielectric layers, capacitance, and rated voltage for each of the multilayer ceramic capacitors of Comparative Examples 1 to 4 and Examples 1 to 7 are as follows:
Dimensions: L×W×T=about 1.0 mm×about 0.5 mm×about 0.5 mm
Ceramic material: BaTiO₃
Thickness of dielectric layer: about 0.5 μm
Capacitance: about 13 μF
Rated voltage: about 6.3 V

The sample was polished so that the WT cross section was exposed at approximately the center of the sample in the length direction L. In order to clarify the boundaries (grain boundaries) between ceramic grains in the dielectric layers, the sample was subjected to a heat treatment. The temperature of the heat treatment was set to a temperature at which ceramic grains do not undergo grain growth and grain boundaries become clear, and in this experimental example, treatment was performed at about 1000° C.

Ceramic grains in the dielectric layer 4, the side gap portion 8, and the outer layer portion 7 were observed at about 30,000× magnification using a scanning electron microscope (SEM) (FIG. 4). The average particle size of the ceramic grains was defined as the median diameter of equivalent circle diameter obtained from image analysis of observation images using a scanning electron microscope (Scanning Electron Microscope: hereinafter, may be abbreviated as SEM). The median diameter of equivalent circle diameter refers to the particle size (D50) at which the cumulative percentage is about 50% in the distribution curve of cumulative percentage with respect to particle size.

The measurement conditions and evaluation criteria for permittivity, AC voltage characteristics, and DC bias characteristics are shown below.

The permittivity was measured at about 3 VDC, about 100 kHz, and about 0.01 V, and the permittivity was evaluated as o (circle symbol indicating “pass”) for 1100 or more, Δ (triangle symbol indicating “acceptable pass”) for 900 or more and less than 1100, and x (cross symbol indicating “fail”) for less than 900.

A capacitance change rate was measured when a measurement voltage is changed to about 0.01 V with respect to about 120 Hz about 0.5 V, and the capacitance change rate was evaluated as o (circle symbol indicating “pass”) for less than about −16%, Δ (triangle symbol indicating “acceptable pass”) for about −16% or more and less than about −25%, and x (cross symbol indicating “fail”) for about −25% or more.

A capacitance change rate was measured when a DC applied voltage was changed from about 0 V to about 3.15 V under measurement conditions of about 100 kHz and about 0.01 V, and the capacitance change rate was evaluated as o (circle symbol indicating “pass”) for less than about −55%, Δ (triangle symbol indicating “acceptable pass”) for about −55% or more and less than about −65%, and x (cross symbol indicating “fail”) for about −65% or more.

Table 1 shows the average particle sizes and evaluation results for each portion in the Examples and Comparative Examples.

TABLE 1

| | Average | | Average | | Average | | | | | | |
|---|---|---|---|---|---|---|---|---|---|---|---|
| | particle | | particle | | particle | | Permittivity | | | | |
| | size Rd of | | size Rs of | | size Ro of | | at 3 VDC, | | | | |
| | dielectric | | side gap | | outer layer | | 100 kHz | AC Voltage | DC bias | | Relational |
| | layer 4 | | portion 8 | | portion 7 | | and 10 mV | Characteristics | characteristics | Determination | Expression |
| Comparative | 330 | nm | 295 | nm | 505 | nm | 890 | −41.20% | −64.90% | X | Rs ≤ Rd < Ro |
| Example 1 | | | | | | | | | | | |
| Comparative | 300 | nm | 245 | nm | 420 | nm | 900 | −44.90% | −65.70% | X | Rs ≤ Rd < Ro |
| Example 2 | | | | | | | | | | | |
| Comparative | 275 | nm | 205 | nm | 405 | nm | 980 | −50.30% | −66.40% | X | Rs ≤ Rd < Ro |
| Example 3 | | | | | | | | | | | |
| Comparative | 250 | nm | 176 | nm | 223 | nm | 870 | −50.30% | −66.40% | X | Rs ≤ Ro < Rd |
| Example | | | | | | | | | | | |
| Example1 | 139 | nm | 145 | nm | 150 | nm | 900 | −22.10% | −64.10% | Δ | Rd ≤ Rs < Ro |
| Example2 | 140 | nm | 151 | nm | 195 | nm | 1100 | −15.90% | −54.70% | ◯ | Rd ≤ Rs < Ro |
| Example3 | 161 | nm | 161 | nm | 201 | nm | 1250 | −13.50% | −51.90% | ◯ | Rd ≤ Rs < Ro |
| Example4 | 165 | nm | 178 | nm | 223 | nm | 1230 | −12.20% | −43.80% | ◯ | Rd ≤ Rs < Ro |
| Example5 | 166 | nm | 192 | nm | 225 | nm | 970 | −16.50% | −58.30% | Δ | Rd ≤ Rs < Ro |

From the results in Table 1, the average particle size Rd of the ceramic grains in the dielectric layer 4, the average particle size Rs of the ceramic grains in the side gap portion 8, and the average particle size Ro of the ceramic grains in the outer layer portion 7 can be expressed by the following relational expression (1).

$$Rd \leq R < Ro \qquad ( 1 )$$

As shown in the results of Examples 2 to 4 in Table 1, the average particle size Rd of the ceramic grains in the dielectric layer 4 is more preferably about 140 nm or more and about 165 nm or less, for example, which ensures that both AC voltage characteristics and DC bias characteristics can be achieved. When the average particle size Rdc is less than about 140 nm, the AC voltage characteristics and DC bias characteristics are likely to deteriorate, and when it exceeds about 165 nm, the AC voltage characteristics and DC bias characteristics are likely to deteriorate.

As shown in the results of Examples 2 to 4 in Table 1, the average particle size Rs of the ceramic grains in the side gap portion 8 is more preferably about 151 nm or more and about 178 nm or less, which ensures that both AC voltage characteristics and DC bias characteristics can be achieved. When the average particle size Rs is less than about 151 nm, the AC voltage characteristics and DC bias characteristics are likely to deteriorate, and when it exceeds about 178 nm, the AC voltage characteristics and DC bias characteristics are likely to deteriorate.

As shown in the results of Examples 2 to 4 in Table 1, the average particle size Ro of the ceramic grains in the outer layer portion 7 is more preferably about 195 nm or more and about 223 nm or less, which ensures that both AC voltage characteristics and DC bias characteristics can be achieved. When the average particle size Rs is less than about 195 nm, the AC voltage characteristics and DC bias characteristics are likely to deteriorate, and when it exceeds about 223 nm, the AC voltage characteristics and DC bias characteristics are likely to deteriorate.

When the average particle size Rdc of the ceramic grains in the middle portion of the dielectric layer 4 in the width direction W is about 137 nm or more and about 172 nm or less, and the average particle size Rde of the ceramic grains at both end portions of the dielectric layer 4 in the width direction W is about 140 nm or more and about 152 nm or less, both AC voltage characteristics and DC bias characteristics can be reliably achieved. When the average particle size Rdc is less than about 137 nm, the AC voltage characteristics and DC bias characteristics are likely to deteriorate, and when it exceeds about 172 nm, the AC voltage characteristics and DC bias characteristics are likely to deteriorate. Further, when the average particle size Rde is less than about 140 nm, the AC voltage characteristics and DC bias characteristics are likely to deteriorate, and when it exceeds about 152 nm, the AC voltage characteristics and DC bias characteristics are likely to deteriorate.

The middle portion of the dielectric layer 4 in the width direction W is a range different from both end portions of the dielectric layer 4 in the width direction W, and refers to within a range about 25 μm from the center in the width direction W. Further, both end portions of the dielectric layer 4 in the width direction W refer to within a range about 25 μm from virtual lines extending in the lamination direction T from both ends of the internal electrode layer 5 provided on the dielectric layer 4 toward the middle portion of the internal electrode layer 4.

From the above, the average particle size Rdc of the ceramic grains in the middle portion of the dielectric layer 4 in the width direction W and the average particle size Rde of the ceramic grains at both end portions of the dielectric layer 4 in the width direction W can be expressed by the following relational expression (2).

$$about 0.81 < Rde / Rdc < about 1.11 \qquad ( 2 )$$

The Si content concentration in the dielectric layer 4 was measured by polishing a cross section so that the WT cross section of the multilayer ceramic capacitor was exposed, and detecting Si by compositional analysis using energy dispersive X-ray spectroscopy (EDX).

As a result of the measurement, the concentration of Si included in the dielectric layer 4 is, for example, about 0.6 mol or more and about 1.2 mol or less with respect to 100 mol of BaTiO₃, thus making it possible to achieve both AC voltage characteristics and DC bias characteristics. When the concentration of Si is less than about 0.6 mol, the AC voltage characteristics and DC bias characteristics are likely to deteriorate more easily, and when the concentration exceeds about 1.2 mol, the AC voltage characteristics and DC bias characteristics are likely to deteriorate more easily.

Further, the concentration of Si [Si]dc in the middle portion of the dielectric layer 4 in the width direction W, the concentration of Si [Si]de in regions 25 μm from both end portions of the dielectric layer 4 in the width direction W, and the concentration of Si [Si]s in the side gap portion 8 can be represented by the following relational expression (3). By satisfying the relational expression (3), it is possible to achieve both AC voltage characteristics and DC bias characteristics.

$$[ Si ] dc \leq [ Si ] de \leq [ Si ] s \qquad ( 3 )$$

Each sample was polished such that a WT cross section was exposed at substantially the middle in the length direction L. After completion of polishing, the polished surface was processed by ion milling in order to eliminate sagging of the internal electrodes due to polishing. The thickness of the dielectric layers was measured using a scanning electron microscope (SEM).

The thickness in the lamination direction T of the dielectric layers 4 of Examples 4 to 6 is about 0.4 μm or more and about 0.8 μm or less, and it is preferable that the thickness in the lamination direction T of the dielectric layers 4 is, for example, about 0.4 μm or more and about 0.8 μm or less.

In the WT cross section, a reference line was determined in the lamination direction T so as to be orthogonal or substantially orthogonal to the internal electrode layer 5, and the number of ceramic grains in the dielectric layer passing through the reference line was measured using a scanning electron microscope (SEM).

It is preferable that the average number of ceramic grains arranged in the lamination direction T in the dielectric layer 4 is about 3.3 or more, for example. By forming the dielectric layer with a dense dielectric, it is possible to provide highly effective capacitance.

As shown in FIG. 5, by making the particle size of ceramic grains in the dielectric layer 4 smaller than that of conventional multilayer ceramic capacitors and forming a uniform core-shell configuration, it is possible to obtain ceramic capacitors that achieve both AC voltage characteristics and DC bias characteristics with low permittivity. Furthermore, by reducing the particle size of ceramic grains, it is possible to reduce or prevent deformation of the multilayer chip during the firing step. Therefore, it is possible to improve electrical characteristics such as, for example, short circuit failure rate, insulation resistance, and breakdown voltage (BDV). Moreover, by increasing the number of grain boundaries, it is possible to improve reliability.

Although example embodiments of the present invention have been described above, the present invention is not limited to the example embodiments, and can be provided in various modes without departing from the scope and gist of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion in which dielectric layers and internal electrode layers are laminated in a lamination direction, outer layer portions sandwiching the inner layer portion in the lamination direction, and side gap portions sandwiching the inner layer portion in a width direction intersecting the lamination direction; and
external electrodes each on a corresponding one of two end surfaces in a length direction intersecting the lamination direction and the width direction of the multilayer body, and each connected to one or more of the internal electrode layers; wherein
an average particle size Rd of ceramic grains in the dielectric layers, an average particle size Rs of ceramic grains in the side gap portions, and an average particle size Ro of ceramic grains in the outer layer portions satisfy Rd≤Rs<Ro.

2. The multilayer ceramic capacitor according to claim 1, wherein the average particle size Rd of ceramic grains in the dielectric layers is about 140 nm or more and about 165 nm or less.

3. The multilayer ceramic capacitor according to claim 1, wherein an average particle size Rdc of ceramic grains in a middle portion in the width direction of the dielectric layers and an average particle size Rde of ceramic grains in two end portions in the width direction of the dielectric layers satisfy about 0.81<Rde/Rdc<about 1.11.

4. The multilayer ceramic capacitor according to claim 1, wherein an Si concentration [Si]dc in a middle portion in the width direction of the dielectric layers, an Si concentration [Si]de in two end portions in the width direction of the dielectric layers, and an Si concentration [Si]s in the side gap portions satisfy [Si]dc≤[Si]de≤[Si]s.

5. The multilayer ceramic capacitor according to claim 1, wherein a thickness of each of the dielectric layers in the lamination direction is about 0.4 μm or more and about 0.8 μm or less.

6. The multilayer ceramic capacitor according to claim 1, wherein an average number of ceramic grains arranged in the lamination direction in the dielectric layers is about 3.3 or more.

7. The multilayer ceramic capacitor according to claim 2, wherein the average particle size Rs of ceramic grains in the side gap portions is about 151 nm or more and about 178 nm or less.

8. The multilayer ceramic capacitor according to claim 7, wherein the average particle size Ro of the ceramic grains in the outer layer portion is about 195 nm or more and about 223 nm or less.

9. The multilayer ceramic capacitor according to claim 2, wherein the average particle size Ro of the ceramic grains in the outer layer portion is about 195 nm or more and about 223 nm or less.

10. The multilayer ceramic capacitor according to claim 1, wherein the average particle size Rs of ceramic grains in the side gap portions is about 151 nm or more and about 178 nm or less.

11. The multilayer ceramic capacitor according to claim 1, wherein the average particle size Ro of the ceramic grains in the outer layer portion is about 195 nm or more and about 223 nm or less.

12. The multilayer ceramic capacitor according to claim 3, wherein the average particle size Rdc of ceramic grains in the middle portion in the width direction of the dielectric layers is about 137 nm or more and about 172 nm or less.

13. The multilayer ceramic capacitor according to claim 3, wherein the average particle size Rde of ceramic grains in the two end portions in the width direction of the dielectric layers is about 140 nm or more and about 152 nm or less.

14. The multilayer ceramic capacitor according to claim 3, wherein the middle portion of the dielectric layers in the width direction is in a range of about 25 μm from a center of the dielectric layers in the width direction.

15. The multilayer ceramic capacitor according to claim 3, wherein the average particle size Rs of ceramic grains in the side gap portions is about 151 nm or more and about 178 nm or less.

16. The multilayer ceramic capacitor according to claim 3, wherein the average particle size Ro of the ceramic grains in the outer layer portion is about 195 nm or more and about 223 nm or less.

17. A multilayer ceramic capacitor comprising:
a multilayer body including an inner layer portion in which dielectric layers and internal electrode layers are laminated in a lamination direction, outer layer portions sandwiching the inner layer portion in the lamination direction, and side gap portions sandwiching the inner layer portion in a width direction intersecting the lamination direction; and
external electrodes each on a corresponding one of two end surfaces in a length direction intersecting the lamination direction and the width direction of the multilayer body; wherein
an average particle size Rd of ceramic grains in the dielectric layers is about 140 nm or more and about 165 nm or less;
an average particle size Rs of ceramic grains in the side gap portions is about 151 nm or more and about 178 nm or less; and
an average particle size Ro of the ceramic grains in the outer layer portion is about 195 nm or more and about 223 nm or less.

18. A multilayer ceramic capacitor comprising:
a multilayer body including an inner layer portion in which dielectric layers and internal electrode layers are laminated in a lamination direction, outer layer portions sandwiching the inner layer portion in the lamination direction, and side gap portions sandwiching the inner layer portion in a width direction intersecting the lamination direction; and
external electrodes each on a corresponding one of two end surfaces in a length direction intersecting the lamination direction and the width direction of the multilayer body; wherein
an average particle size Rde of ceramic grains in the two end portions in the width direction of the dielectric layers is about 140 nm or more and about 152 nm or less;
an average particle size Rdc of ceramic grains in the middle portion in the width direction of the dielectric layers is about 137 nm or more and about 172 nm or less;
an average particle size Rs of ceramic grains in the side gap portions is about 151 nm or more and about 178 nm or less; and
an average particle size Ro of the ceramic grains in the outer layer portion is about 195 nm or more and about 223 nm or less.
